(19) United States
(12) Patent Application Publication
(10) Pub. No.: US 2012/0285318 A1
(43) Pub. Date: Nov. 15, 2012

(54) Lifting Mechanism

(75) Inventors: Soenke Jessen, Tamm (DE); Dominik Fauser, Aspach (DE)

(73) Assignee: Robert Bosch GmbH, Stuttgart (DE)

(21) Appl. No.: 13/466,925

(22) Filed: May 8, 2012

(30) Foreign Application Priority Data
May 14, 2011 (DE) 10 2011 101 553.5

(51) Int. Cl. F15B 9/09; F15B 11/028

(52) U.S. Cl. 91/403; 91/404

(57) ABSTRACT

A lifting mechanism is disclosed which is operated hydraulically and is configured to be mounted or used on a mobile working machine. The lifting mechanism or its hydraulics have a relieving pressure limiting valve which can be regulated as a function of the ground profile. For this purpose, a directly or indirectly measuring sensor arrangement is provided. Furthermore, a method is disclosed which serves for regulating a relieving pressure of a lifting mechanism of a mobile working machine. The method has the following steps (i) detection of the ground profile via a sensor arrangement, and (ii) limitation of the relieving pressure of a relieving line by setting an opening pressure of an electronically activatable proportional relieving pressure limiting valve via a control unit as a function of signals from the sensor arrangement.

This application claims priority under 35 U.S.C. §119 to German patent application no. DE 10 2011 101 553.5, filed May 14, 2011 in Germany, the disclosure of which is incorporated herein by reference in its entirety.

### BACKGROUND

The disclosure relates to a hydraulically actuated lifting mechanism for a mobile working machine according to the preamble of Patent Claim 1 and to a method for controlling said lifting mechanism.

Lifting mechanisms for mobile working machines are known from the prior art and make available a relieving force when a mounted implement coupled to them are in a state in which it is lowered to the ground. A large part of the weight force of the mounted implement is thereby compensated so as to minimize the resistance of the mounted implement rubbing against the ground.

In this case, applications with relieving springs, the relieving force of which is not constant on account of the spring characteristic curves, are known. Furthermore, hydraulic relieving cylinders and hydraulic accumulators for relieving purposes are known.

The lifting mechanisms described above have the disadvantage that too high a relieving force or too high a relieving pressure may relieve the mounted implement in such a way that it lifts off in the case of a descending ground profile. When the lifting mechanism is, for example, a front lifting mechanism and the mounted implement is, for example, a reaper on skids, too great a cutting height occurs if the working machine drives into a depression or after it drives over a bump.

The publication DE 10 207 040 877 A1 discloses a lifting mechanism, the hydraulic arrangement of which has a relieving pressure limiting valve which can be set by the driver of the mobile working machine. The driver can consequently select a desired value of the relieving pressure and thus adapt it, for example, to the weight of the mounted implement.

Even a residual weight of the mounted implement which is selected in this way is always a compromise between a low driving resistance of the mobile working machine and a good follow-up of the mounted implement in the event of unevenesses in the ground, since the relieving pressure remains set for a lengthy period of time (for example, during the reaping of a meadow).

### SUMMARY

By contrast, the object of the disclosure is to provide a hydraulically actuated lifting mechanism and a method for controlling it, which, despite minimized driving resistance of a coupled mounted implement, an improved follow-up of the mounted implement in the case of unevenesses in the ground becomes possible.

This object is achieved by way of a lifting mechanism with relieving pressure regulation, having the features set forth herein, and by way of a method for its activation, having the features also set forth herein.

The lifting mechanism according to the disclosure is operated hydraulically and is intended to be mounted or used on a mobile working machine, in particular on a tractor. The lifting mechanism or its hydraulics have a relieving pressure limiting valve which can be regulated as a function of positive or negative gradient rates in the ground profile over which the mobile working machine is driven. These gradient rates are defined, for the present text, as the height difference or height change (Δh) of the ground in relation to the time (Δt) and, in the extreme case of a descending step in the ground profile, may even be infinitely high. The time in this case depends, on the one hand, on the speed at which the mobile working machine drives over the height difference and, on the other hand, on the gradient or slope of the height difference. A sensor arrangement is provided for detecting the gradient rates. A hydraulically actuated lifting mechanism is consequently provided, in which, despite a minimized driving resistance by a reduction in the weight force of a coupled mounted implement, for example to 20%, an improved quick-reaction follow-up of the mounted implement in the case of comparatively abrupt (steep and/or sudden) unevennesses in the ground becomes possible. Furthermore, the mounted implement having the relieving pressure regulation according to the disclosure can be pushed or pulled during normal operation with higher relief (by means of higher relieving pressure), with the result that fuel is saved.

Further advantageous refinements of the disclosure are described below.

The mounted implement may be, for example, a reaper, a snow plough, a packer roller or a mulcher.

Preferably, the relieving pressure limiting valve is a proportional pressure limiting valve activatable electronically by a control unit or electronic control unit (ECU).

In a preferred development which entails low outlay in terms of apparatus, the sensor arrangement is formed by an angular speed transducer, via which an angular speed between a connecting rod, in particular a lower connecting rod, and the mobile working machine is measurable.

The angular speed transducer is preferably formed by an angle transducer in cooperation with the control unit. The angular speed of the connecting rod in relation to the mobile working machine can be measured via the angle transducer by the control unit by differentiating the angle.

The sensor arrangement may also have a distance sensor which is arranged in front of the mobile working machine or in front of the mounted implement in the direction of travel of the mobile working machine and which detects the ground profile directly, for example by laser or ultrasound. This affords a prolonged time which can be utilized for the lifting mechanism or for the control unit in order to react optimally to the gradient rate in the ground profile.

In a preferred development, when a reduction in the height of the ground is determined by the sensor arrangement, a first opening pressure of the relieving pressure limiting valve is set, and, when an increase in the height of the ground is determined by the sensor arrangement, a second opening pressure of the relieving pressure limiting valve is set. The first opening pressure is then lower than the second opening pressure, for example by an amount of 25-50%.

Preferably, the relieving pressure limiting valve is arranged on a relieving pressure line, via which a relieving pressure space can be supplied.

In addition, a loading pressure line may be provided, via which a loading pressure space, which counteracts the relieving pressure space, is supplied. Consequently, a downwardly acting accelerating force can act upon the working implement, in order to ensure optimal follow-up even in the case of an especially abruptly descending ground profile or an especially lightweight working implement, or in order to compensate a slowly falling relieving pressure.

In this case, it is especially preferable if a loading pressure in the loading pressure line can also be regulated by a loading pressure limiting valve via the sensor arrangement as a function of the gradient rate in the ground profile.

The method according to the disclosure serves for regulating a relieving pressure of a lifting mechanism of a mobile working machine and has the steps:
detection of a positive or negative gradient rate in the ground profile via a sensor arrangement; and
limitation of the relieving pressure, for example of a relieving line, by setting an opening pressure of an electronically activatable proportional relieving pressure limiting valve via a control unit as a function of the gradient rate.

The gradient rate may in this case, in the extreme case of a descending step in the ground profile, even be infinitely high. A method is consequently provided, in which, despite a minimized driving resistance by a reduction in the weight force of a coupled mounted implement, for example to 20%, improved quick-reaction follow-up of the mounted implement in the case of unevenesses in the ground is possible. Furthermore, during normal operation, the mounted implement can be pushed or pulled with higher relief (by means of a higher relieving pressure) with the result that fuel is saved.

In an especially preferred development of the method according to the disclosure, when the opening pressure is being set it is reduced briefly (for example, 200-400 ms) in a pulse-like manner. Consequently, the hysteresis of the overall system is overcome and the mounted implement is accelerated downward with increased weight force.

Preferably, in addition, limitation of a loading pressure, for example of a loading line, is carried out by setting an opening pressure of an electronically activatable proportional loading pressure limiting valve via the control unit as a function of the signals from the sensor arrangement. Consequently, optimal follow-up can be ensured in the case of an especially abruptly descending ground profile or an especially lightweight working implement, or a slowly falling relieving pressure can be compensated.

It is especially expedient if, when a negative gradient rate of the ground profile is determined by the sensor arrangement, the opening pressure of the relieving pressure limiting valve is reduced, while, when a positive gradient rate is determined by the sensor arrangement, the opening pressure of the relieving pressure limiting valve can also be increased.

The detection of the gradient rate of the ground profile is preferably carried out by measuring an angular speed, for example by differentiating the angle, between a connecting rod, in particular a lower connecting rod, and the mobile working machine.

In an especially preferred development of the method according to the disclosure, the limitation of the relieving pressure takes place only when a predetermined height difference is overshot or undershot and is determined via the sensor arrangement. This ensures that brief slumping or short-travel swinging of the mounted implement does not lead to regulation according to the disclosure.

### BRIEF DESCRIPTION OF THE DRAWINGS

An exemplary embodiment of the disclosure is described in detail below by means of the figures in which:

FIG. 1 shows a tractor to which a reaper is coupled via a lifting mechanism according to the disclosure, in a side view;

FIG. 2 shows a simplified circuit diagram of a hydraulic arrangement of the lifting mechanism according to the disclosure;

FIG. 3 shows a course of an angular position and a corresponding annular speed of a lower connecting rod of the lifting mechanism according to the disclosure; and

FIG. 4 shows a course of a relieving pressure in relation to FIG. 3.

### DETAILED DESCRIPTION

The disclosure is explained below with reference to a double-acting front lifting mechanism 1 of a tractor. The basic set-up of this front lifting mechanism 1 is described in detail in DE 10 2005 005 314 A1, and therefore only the structural elements essential for understanding the disclosure are dealt with here and reference is otherwise made to the disclosure of the publication mentioned.

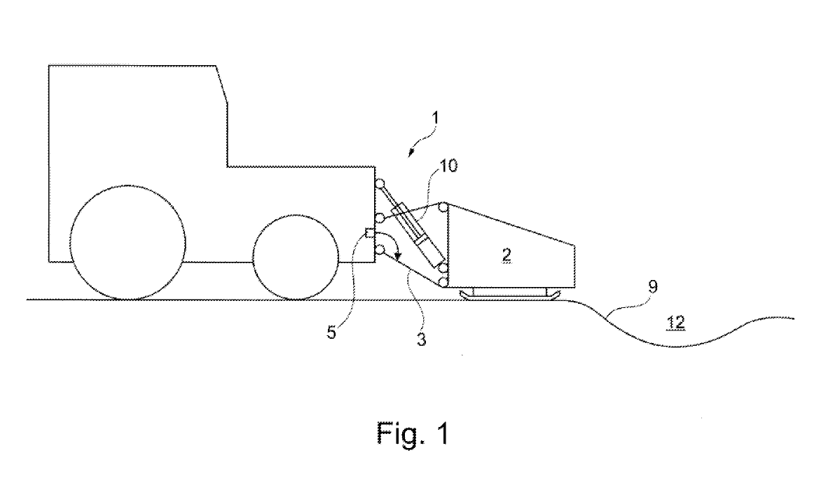

FIG. 1 shows a side view of the tractor to which a reaper 2 is coupled via the front lifting mechanism 1 according to the disclosure. The front lifting mechanism 1 has a lifting cylinder 10 which acts as a relieving cylinder and as a loading cylinder. However, a hydraulic arrangement of the single-acting type may also be envisaged. A connecting rod arrangement carrying the reaper 2 and articulated on the tractor can be pivoted via the lifting cylinder 10 in order to raise or lower the reaper 2. An angle between the tractor and a lower connecting rod 3 of the connecting rod arrangement is determined via an angle transducer 5. This angle is increased when the reaper 2 is pushed with its skids 7 over a slope 9 into a depression 12 or down from a bump (not shown). The angle is reduced when the reaper 2 is pushed over a gradient out of the depression 12 or onto a bump (not shown).

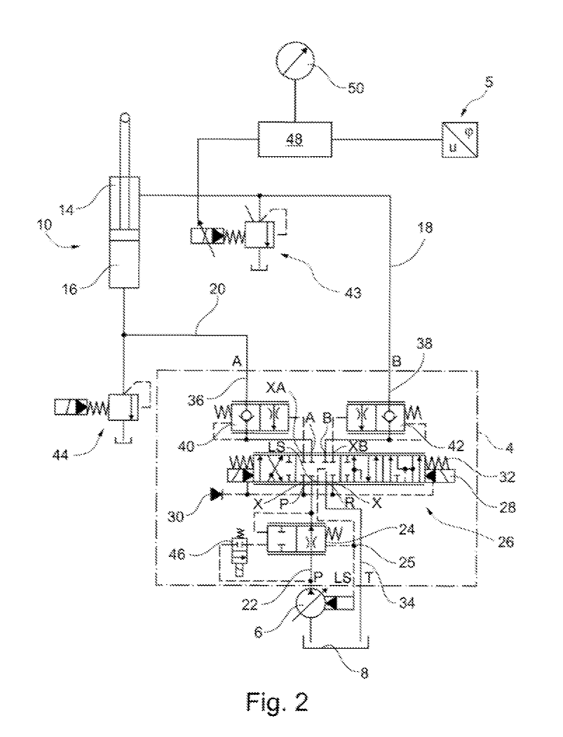

The hydraulic circuit diagram illustrated in FIG. 2 serves for controlling the front lifting mechanism 1 via the lifting cylinder 10. The movement of a piston rod of the lifting cylinder 10 takes place via a lifting mechanism valve arrangement 4, via which two pressure spaces 14, 16 of the lifting cylinder 10 can be connected to a variable displacement pump 6 or a tank 8. The lifting cylinder 10 has a relieving pressure space 14 active in the “carrying” direction and a loading pressure space 16 active in the “pressing down” direction, which are connected in each case via working lines 18, 20 to working connections A, B of the lifting mechanism valve arrangement 4.

The set-up of lifting mechanism valve arrangements 4 of this type is described, for example, in data sheet RD 66 130/02.07 or RD 66 165/09.04 of Bosch Rexroth AG. These lifting mechanism valve arrangements 4 are conventionally executed in a disk-type construction and are integrated in a mobile control block of the tractor. In the exemplary embodiment illustrated, the lifting mechanism valve arrangement 4 has a pressure connection P and a tank connection T which are connected to the variable displacement pump 6 and the tank 8 respectively. The lifting mechanism valve arrangement 4 is designed as a load sensing system. Arranged in an inflow duct 22 connected to the pressure connection P is a load sensing pressure balance 24 which is acted upon in the opening direction by the force of a spring and by the load pressure of the lifting cylinder 10 in a load sensing duct 25 and in the closing direction by the pump pressure downstream of the load sensing pressure balance 24.

The inflow duct 22 leads to a pressure connection P of a continuously adjustable directional valve 26 which can be adjusted via a pilot valve arrangement 28. The latter is composed, for example, of pilot valves which can be activated via a joystick and are connected to a control oil supply 30. A valve slide of the directional valve 26 is prestressed via a centering spring arrangement 32 into a basic position, illustrated in FIG. 2, in which the inlet connection P and also two working connections A, B and control connections XA, XB, X are shut off and a load sensing connection LS is connected to a return connection R. The return connection R is connected via a tank duct 34 to the tank connection T of the lifting mechanism valve arrangement 4.

By virtue of the pilot valve arrangement 28 being suitably set, the valve slide of the directional valve 26 can be adjusted out of its basic position (in FIG. 2) to the right into relief positions in which a pressure medium connection from the inlet connection P to the working connection B of the directional valve 26 is opened via a metering diaphragm, so that pressure medium is correspondingly conveyed into the relieving pressure space 14 of the lifting cylinder 10. The pressure medium displaced out of the loading pressure space 16 flows in this case via the working connection A connected to the return connection R out to the tank 8. When the valve slide is adjusted to the left in FIG. 2 into load positions, a pressure medium connection from the pressure connection P to the working connection A of the directional valve 26 is made via the metering diaphragm, and the working connection B is connected to the return connection R, so that pressure medium is correspondingly conveyed into the loading pressure space 16 in order to press down the reaper 2. The pressure medium displaced out of the relieving pressure space 14 flows out to the tank 8.

When the valve slide of the directional valve 26 (in FIG. 2) is displaced to the left into a floating position, the two working connections A, B of the directional valve 26 and therefore also the two pressure spaces 14, 16 of the lifting cylinder 10 are connected to the return connection R, so that the reaper 2 lies on the ground without any application of force by the lifting mechanism.

The two working connections A, B of the directional valve 26 are connected via a forward flow duct 36 or an outflow duct 38 to the working connections A, B of the lifting mechanism valve arrangement 4. A lowering module 40, 42 is arranged in each case in the ducts 36, 38 and, in a spring-prestressed basic position acts as a releasable nonreturn valve for leakage oil-free clamping of the lifting cylinder 10 and, in regulating positions, controls the pressure medium volume flow flowing back from the lifting cylinder 10 with the effect of outflow regulation. For this purpose, each lowering module 40, 42 is acted upon in the direction of its nonreturn position by the pressure of the assigned working connection A, B of the directional valve 26 and in the direction of its opening/throttle position by the control pressure of the control oil supply 30.

The individual load pressure of the lifting cylinder 10 is picked off via the load sensing connection LS of the directional valve 26 and acts upon the individual pressure balance or load sensing pressure balance 24 in the opening direction, as already mentioned.

For retracting the lifting cylinder 10 and consequently for relieving or raising the reaper 2, the directional valve 26 is adjusted in such a way that the pressure medium is conveyed from the variable displacement pump 6 via the inflow duct 22, the load sensing pressure balance 24, the opened metering diaphragm of the directional valve 26, the working connection B of the directional valve 26, the nonreturn valve of the lowering module 42, and the outflow duct 38 and the working line 18 into the relieving pressure space 14. The pump pressure is in this case set, to save energy, such that it is always only a predetermined pressure difference above the highest load pressure of all the consumers, for example the lifting cylinder 10, of the tractor (load sensing). The pressure medium displaced out of the loading pressure space 16 during the retraction of the lifting cylinder 10 flows via the working line 20, the forward flow duct 36, the lowering module 40 opened via the control pressure in the control oil supply 30, the connections A, R of the directional valve 26 and the tank duct 34 out to the tank 8. The lowering module 40 in this case acts as an outflow pressure balance, via which the outflowing pressure medium volume flow is regulated to a certain extent.

In the exemplary embodiment illustrated in FIG. 2, the pressure balance 24 can be fixed in its closing position in that the control face active in the closing direction is acted upon via an electrically actuated 2/2-way pilot valve 46 with the pressure upstream of the pressure balance 24 which, as already mentioned above, is in any event higher than the load pressure of the lifting cylinder 10. This closing makes it possible to shut off the pressure medium flow path between the variable displacement pump 6 and the directional valve 26 in spite of the opened metering diaphragm.

The pressure in the working line 20 can be limited via a continuously adjustable loading pressure limiting valve 44, so that the pressure in the loading pressure space 16 can be set independently of the setting of the directional valve 26 and of the pump pressure, for example in the range of between 5 and 230 bar. Thus, by the loading pressure limiting valve 44 being adjusted to its minimum pressure, for example 5 bar, the actually double-acting front lifting mechanism 1 can be operated as single-acting, so that, even when the directional valve 26 is set to its load positions, the reaper 2 sinks down virtually only on account of its dead weight. After lowering, the directional valve 26 can then be adjusted into its floating position, so that any unevenesses in the ground can be compensated. This behavior then corresponds to that of conventional single-acting lifting mechanism.

Furthermore, the working line 18 has provided in it a relieving pressure limiting valve 43 which is likewise designed to be continuously adjustable and via which the pressure in the working line 18 can be limited, for example, to values of between 5 and 230 bar. The relieving pressure limiting valve 43 is a proportional pressure limiting valve which is activated by an electronic control apparatus or by an electronic control unit 48. This takes place as a function of a potentiometer 50 which is set by the driver of the tractor. Furthermore, according to the disclosure, the electronic activation of the relieving pressure limiting valve 43 takes place via electronic regulation as a function of the angle transducer 5 which converts the current angle between the lower connecting rod 3 and the tractor (cf. FIG. 1) into a voltage or current signal.

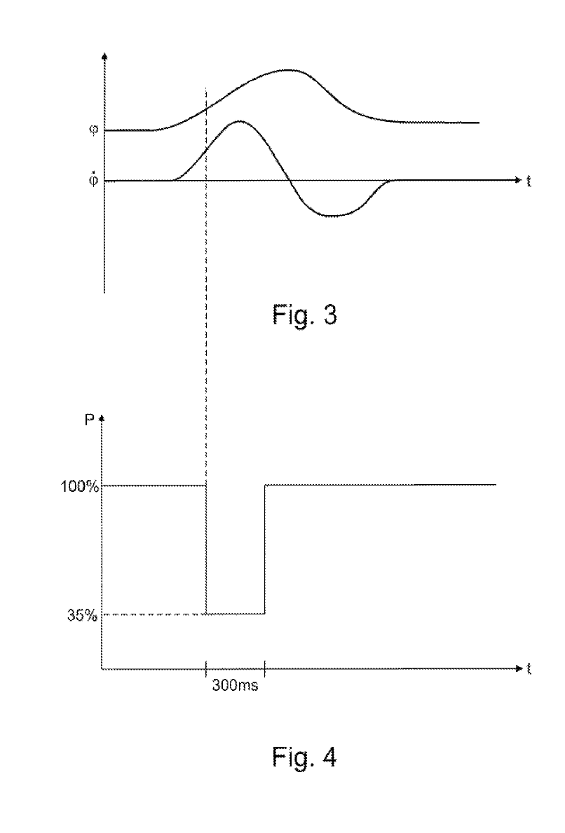

FIG. 3 shows an exemplary angle course φ between the lower connecting rod 3 and the tractor (cf. FIG. 1) over time. It illustrates driving through the depression 12 (cf. FIG. 1), leading to a transitional increase in the angle φ.

Furthermore, in FIG. 3, the angular speed determined by differentiating the angle course φ is plotted against time. This is carried out by the control unit 48.

FIG. 4 shows the diagrammatic course of the relieving pressure over time with reference to the example from FIG. 3. This illustrates that the relieving pressure of 100%, selected particularly as a function of the dead weight of the reaper 2, is briefly lowered sharply immediately after a predetermined positive angular speed is overshot. In this case, for example, lowering to 35% of the previously selected relieving pressure can be carried out for a duration of 300 ms. Rapid follow-up or lowering of the reaper 2 (cf. FIG. 1) downward is consequently made possible.

Above and beyond the exemplary embodiment shown, the loading pressure limiting valve 44 can also be set briefly to a higher opening pressure when a certain angular speed is overshot, so that the reaper 2 is additionally loaded briefly and is therefore lowered more quickly.

Contrary to the exemplary embodiment shown, the angle transducer may also be replaced by a distance sensor arranged on the tractor or preferably further forward on the reaper in the direction of travel.

A lifting mechanism is disclosed which is operated hydraulically and is intended to be mounted or used on a mobile working machine. The lifting mechanism or its hydraulics have a relieving pressure limiting valve which can be regulated as a function of the ground profile. For this purpose, a directly or indirectly measuring sensor arrangement is provided.

Furthermore, a method is disclosed which serves for regulating a relieving pressure of a lifting mechanism of a mobile working machine. The method has the steps:
detection of the ground profile via a sensor arrangement; and
limitation of the relieving pressure of a relieving line by setting an opening pressure of an electronically activatable proportional relieving pressure limiting valve via a control unit as a function of signals from the sensor arrangement.

### LIST OF REFERENCE SYMBOLS

1 Front lifting mechanism
2 Reaper
3 Lower connecting rod
4 Lifting mechanism valve arrangement
5 Angle transducer
6 Variable displacement pump
7 Skid
8 Tank
9 Slope
10 Lifting cylinder
12 Depression
14 Relieving pressure space
16 Loading pressure space
18 Working line
20 Working line
22 Inflow duct
24 Load sensing pressure balance
26 Directional valve
28 Pilot valve arrangement
30 Control oil supply
32 Centering spring arrangement
34 Tank duct
36 Forward flow duct
38 Outflow duct
40 Lowering module
42 Lowering module
43 Relieving pressure limiting valve
44 Loading pressure limiting valve
45 Electromagnet
46 Pilot valve
48 Control unit
Δh Height change

What is claimed is:

1. A hydraulically actuated lifting mechanism for a mobile working machine, comprising:
a relieving pressure limiting valve; and
a sensor arrangement,
wherein the relieving pressure limiting valve is configured to be regulated as a function of a height change (Δh), detected by the sensor arrangement of a ground profile per unit time.

2. The hydraulically actuated lifting mechanism according to claim 1, further comprising a control unit, wherein:
the relieving pressure limiting valve is a proportional pressure limiting valve that is configured to be activated electronically by the control unit.

3. The hydraulically actuated lifting mechanism according to claim 2, further comprising a connecting rod, wherein:
the sensor arrangement has an angle transducer which is connected to the control unit, and
an angular speed between the connecting rod and the mobile working machine is measurable via the angle transducer and the control unit.

4. The hydraulically actuated lifting mechanism according to claim 1, further comprising a first working line, wherein:
the relieving pressure limiting valve is arranged on the first working line via which a relieving pressure space can be supplied.

5. The hydraulically actuated lifting mechanism according to claim 4, further comprising a second working line, via which a loading pressure space, which counteracts the relieving pressure space, can be supplied.

6. The hydraulically actuated lifting mechanism according to claim 5, further comprising a loading pressure limiting valve, wherein:
a loading pressure in the second working line is configured to be regulated by the loading pressure limiting valve as a function of the height change (Δh) of the ground profile per unit time.

7. A method for regulating a relieving pressure of a lifting mechanism of a mobile working machine, comprising:
detecting a height change (Δh) of a ground profile per unit time via a sensor arrangement; and
limiting the relieving pressure by setting an electronically activatable proportional relieving pressure limiting valve via a control unit as a function of signals from the sensor arrangement.

8. The method according to claim 7, further comprising:
limiting a loading pressure by setting an electronically activatable proportional loading pressure limiting valve via the control unit as a function of the signals from the sensor arrangement.

9. The method according to claim 7, further comprising:
when a reduction in the height of the ground profile is determined by the sensor arrangement, an opening pressure of the relieving pressure limiting valve is reduced, or, when an increase in the height of the ground profile is determined by the sensor arrangement, the opening pressure of the relieving pressure limiting valve is increased.

10. The method according to claim 7, further comprising:
measuring an angular speed between a connecting rod and the mobile working machine so as to detect the height change (Δh) of the ground profile per unit time.

11. The method according to claim 7, wherein the limiting step occurs only when the amount of a predetermined height change (Δh) is overshot.
